(19) United States
(12) Patent Application Publication
(10) Pub. No.: US 2025/0252938 A1
(43) Pub. Date: Aug. 7, 2025

(54) REED MUSICAL INSTRUMENT FOR CUSTOMIZABLY PRODUCING MUSICAL SOUNDS

(71) Applicant: Tejas Pradip Rode, Houston, TX (US)

(72) Inventor: Tejas Pradip Rode, Houston, TX (US)

(21) Appl. No.: 18/429,467

(22) Filed: Feb. 1, 2024

(51) Int. Cl. G10B 1/08; G10B 3/00

(52) U.S. Cl. CPC G10B 1/08; G10B 3/00

(57) ABSTRACT

A reed musical instrument for customizably producing musical sounds comprising a body and a device. The body includes an airflow device for establishing an airflow in an interior of the body and a reed. The device includes an internal sensor for detecting a characteristic associated with the airflow, a processing device for generating an airflow information based on the detecting of the characteristic associated with the airflow and synthesizing a musical sound using a reed data associated with the reed based on the airflow information and a customization information, a storage device for storing the reed data, and an output device for producing the musical sound based on the synthesizing of the musical sound.

### FIELD OF THE INVENTION

Generally, the present disclosure relates to the field of musical instruments. More specifically, the present disclosure relates to a reed musical instrument for customizably producing musical sounds.

### BACKGROUND OF THE INVENTION

Existing reed musical instruments are deficient in regard to several aspects. For instance, current reed musical instruments are not able to be played in multiple scales while maintaining just-intonation tuning. Furthermore, current reed musical instruments are not able to be tuned as per the requirements of a vocalist (while accompanying the vocalist). Moreover, each of the current reed musical instruments is not able to be played in every pitch.

Therefore, there is a need for a reed musical instrument for customizably producing musical sounds that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a reed musical instrument for customizably producing musical sounds, in accordance with some embodiments. Accordingly, the reed musical instrument may include a body and a device. Further, the body may include an airflow device and at least one reed. Further, the airflow device may be configured for establishing an airflow in an interior of the body. Further, the device may be configured to be implemented in the body. Further, the device may include at least one internal sensor, a processing device, a storage device, and at least one output device. Further, the at least one internal sensor may be disposed in the interior of the body. Further, the at least one internal sensor may be configured for detecting at least one characteristic associated with the airflow. Further, the processing device may be communicatively coupled the at least one internal sensor. Further, the processing device may be configured for generating an airflow information based on the detecting of the at least one characteristic associated with the airflow in the interior of the body. Further, the processing device may be configured for synthesizing at least one musical sound using at least one reed data associated with the at least one reed based on the airflow information and at least one customization information. Further, the storage device may be communicatively coupled with the processing device. Further, the storage device may be configured for storing the at least one reed data. Further, the at least one output device may be communicatively coupled with the processing device. Further, the at least one output device may be configured for producing the at least one musical sound based on the synthesizing of the at least one musical sound.

Further disclosed herein is a reed musical instrument for customizably producing musical sounds, in accordance with some embodiments. Accordingly, the reed musical instrument may include a body and a device. Further, the body may include an airflow device, at least one reed, and at least one key. Further, the airflow device may be configured for establishing an airflow in an interior of the body. Further, the at least one key corresponds to the at least one reed. Further, the device may be configured to be implemented in the body. Further, the device may include at least one switch, at least one internal sensor, a processing device, a storage device, and at least one output device. Further, the at least one switch may be configured for detecting at least one playing action corresponding to the at least one key. Further, the at least one internal sensor may be disposed in the interior of the body. Further, the at least one internal sensor may be configured for detecting at least one characteristic associated with the airflow. Further, the processing device may be communicatively coupled the at least one internal sensor and the at least one switch. Further, the processing device may be configured for generating at least one key playing information based on the detecting of the at least one playing action. Further, the processing device may be configured for generating an airflow information based on the detecting of the at least one characteristic associated with the airflow in the interior of the body. Further, the processing device may be configured for synthesizing at least one musical sound using at least one reed data associated with the at least one reed based on the at least one key playing information, the airflow information, and at least one customization information. Further, the storage device may be communicatively coupled with the processing device. Further, the storage device may be configured for storing the at least one reed data. Further, the at least one output device may be communicatively coupled with the processing device. Further, the at least one output device may be configured for producing the at least one musical sound based on the synthesizing of the at least one musical sound.

Further disclosed herein is a reed musical instrument for customizably producing musical sounds, in accordance with some embodiments. Accordingly, the reed musical instrument may include a body and a device. Further, the body may include an airflow device, at least one reed, and at least one key. Further, the airflow device may be configured for establishing an airflow in an interior of the body. Further, the at least one key corresponds to the at least one reed. Further, the device may be configured to be implemented in the body. Further, the device may include at least one switch, at least one internal sensor, at least one external sensor, a processing device, a storage device, and at least one output device. Further, the at least one switch may be configured for detecting at least one playing action corresponding to the at least one key. Further, the at least one internal sensor may be disposed in the interior of the body. Further, the at least one internal sensor may be configured for detecting at least one characteristic associated with the airflow. Further, the at least one external sensor may be disposed in an exterior of the body. Further, the at least one external sensor may be configured for detecting at least one characteristic of air associated with the exterior of the body. Further, the processing device may be communicatively coupled the at least one internal sensor, the at least one external sensor, and the at least one switch. Further, the processing device may be configured for generating at least one key playing information based on the detecting of the at least one playing action. Further, the processing device may be configured for determining at least one relative characteristic based on the detecting of the at least one characteristic of the air associated with the exterior of the body and the detecting of the at least one characteristic of the airflow in the interior of the body. Further, the processing device may be configured for generating an airflow information based on the determining. Further, the processing device may be configured for synthesizing at least one musical sound using at least one reed data associated with the at least one reed based on the at least one key playing information, the airflow information, and at least one customization information. Further, the storage device may be communicatively coupled with the processing device. Further, the storage device may be configured for storing the at least one reed data. Further, the at least one output device may be communicatively coupled with the processing device. Further, the at least one output device may be configured for producing the at least one musical sound based on the synthesizing of the at least one musical sound.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a reed musical instrument 100 for customizably producing musical sounds, in accordance with some embodiments.

FIG. 2 is a block diagram of the device 104 of the reed musical instrument 100, in accordance with some embodiments.

FIG. 3 is a block diagram of the device 104 of the reed musical instrument 100, in accordance with some embodiments.

FIG. 4 is a block diagram of the device 104 of the reed musical instrument 100, in accordance with some embodiments.

FIG. 5 is a block diagram of the device 104 of the reed musical instrument 100, in accordance with some embodiments.

FIG. 6 is a block diagram of the device 104 of the reed musical instrument 100, in accordance with some embodiments.

FIG. 7 is a block diagram of the device 104 of the reed musical instrument 100, in accordance with some embodiments.

FIG. 8 is a block diagram of the device 104 of the reed musical instrument 100, in accordance with some embodiments.

FIG. 9 is a top view of the reed musical instrument 100, in accordance with some embodiments.

FIG. 10 is a top view of the reed musical instrument 100 with the cover 108 in the opened state, in accordance with some embodiments.

FIG. 11 is a partial internal view of the reed musical instrument 100, in accordance with some embodiments.

FIG. 12 is a partial internal view of the reed musical instrument 100, in accordance with some embodiments.

FIG. 13 is a partial enlarged view of the at least one reed 1202-1204 of the reed musical instrument 100, in accordance with some embodiments.

FIG. 14 is a front view of the device 104 of the reed musical instrument 100, in accordance with some embodiments.

FIG. 15 is a rear view of the device 104 of the reed musical instrument 100, in accordance with some embodiments.

FIG. 16 is a flow diagram of a process 1600 for synthesizing the musical sound using the reed musical instrument 100, in accordance with some embodiments.

FIG. 17 is a top view of a reed musical instrument 1700 for customizably producing musical sounds, in accordance with some embodiments.

FIG. 18 is a block diagram of the device 1704 of the reed musical instrument 1700, in accordance with some embodiments.

FIG. 19 is a top view of a reed musical instrument 1900 for customizably producing musical sounds, in accordance with some embodiments.

FIG. 20 is a block diagram of the device 1904 of the reed musical instrument 1900, in accordance with some embodiments.

FIG. 21 is an illustration of an online platform 2100 consistent with various embodiments of the present disclosure.

FIG. 22 is a block diagram of a computing device 2200 for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a reed musical instrument for customizably producing musical sounds, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, and a representative thereof. Further, the user as defined herein may refer to a human, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

### Overview

The present disclosure describes a reed musical instrument for customizably producing musical sounds. Further, the reed musical instrument is an augmented electronic acoustic harmonium. Further, the augmented electronic acoustic harmonium may be reversibly converted to an acoustic harmonium (or a conventional harmonium). The augmented electronic acoustic harmonium solves three major problems associated with the conventional harmonium, namely the conventional harmonium's inability to be played in multiple scales while maintaining just-intonation tuning, its inability to be tuned as per the requirements of the vocalist (while accompanying the vocalist), and the conventional harmonium player's need to possess multiple harmoniums to cater to all the ranges of pitch.

Further, the augmented electronic acoustic harmonium synthesizes musical sound merely and does not use sampled (pre-recorded) sound. The musical sound may be created from scratch using acoustic modeling of reeds, making it fully customizable before and while playing the instrument (augmented electronic acoustic harmonium).

Further, the playability of the augmented electronic acoustic harmonium is not different from the conventional harmoniums, as the physical body of the augmented electronic acoustic harmonium is that of a conventional harmonium itself. This makes it easy and intuitive for professional harmonium players to transition and use the augmented electronic acoustic harmonium. Further, the augmented electronic acoustic harmonium has form factors similar to the conventional harmoniums.

Further, the augmented electronic acoustic harmonium may include a user interface for enabling user interactions for modifying harmonium settings. Further, the user interface and the user interactions are minimal. In most practical situations, there is no need to modify the harmonium settings.

Further, the augmented electronic acoustic harmonium may be made up of retrofitting electronics in existing conventional acoustic harmoniums. Further, the retrofitting of the electronics in the existing conventional acoustic harmoniums allows reversibly converting the existing conventional acoustic harmoniums into the augmented electronic acoustic harmonium, thus reducing the need to buy new harmoniums. It also helps traditional harmonium makers by creating new technology business avenues for them. The augmented electronic acoustic harmonium uses standard building techniques to leverage traditional instrument-making wisdom.

Further, the augmented electronic acoustic harmonium allows adjusting audio characteristics of the musical sound produced by the augmented electronic acoustic harmonium depending on other instruments or music being played in the environment of the augmented electronic acoustic harmonium, to make augmented electronic acoustic harmonium sound balanced in any environment. Further, the augmented electronic acoustic harmonium allows automatic adjusting of the audio characteristics of the musical sound produced by the augmented electronic acoustic harmonium depending on other instruments or music being played in the environment.

Further, the augmented electronic acoustic harmonium logs the keys that are played by the augmented electronic acoustic harmonium. The logs may be used for multiple applications like educational (where a teacher can create digital notes for a student, or future reference), data analysis (where the characteristics of a ‘raag’ may be studied mathematically by analyzing its log files generated by the augmented electronic acoustic harmonium), training machine learning models (which may be used to classify or generate music), and other such applications.

Further, the augmented electronic acoustic harmonium uses two pressure sensors at different points of the harmonium giving an accurate estimate of the internal and external pressure to create a refined acoustic model of the reeds as the augmented electronic acoustic harmonium has bellows.

Further, the augmented electronic acoustic harmonium uses a microcontroller that results in very low latency in the musical sound generation after detecting the key presses.

Further, the augmented electronic acoustic harmonium provides reed combination customization. Further, the reed combination customization gives the musician the ability to use a particular combination that is suitable for a performance, especially when accompanying a vocalist. For female vocalists, male-male combinations are used, while for male vocalists, bass-male or, in some cases, bass-bass combinations are used.

Further, the augmented electronic acoustic harmonium provides preset tunings based on the drone. Further, using the preset tunings the augmented electronic acoustic harmonium may quickly match the drone being played. The drones are usually ‘madhyam’ or ‘pancham’.

Further, the augmented electronic acoustic harmonium provides air ventilation control through a software that allows the user to determine the tightness of the bellows. Different bellow tightnesses are used for different playing styles.

Further, the augmented electronic acoustic harmonium provides automatic preferred key customization that allows a user to play in any pitch while being in their key of comfort.

Further, the augmented electronic acoustic harmonium provides a 5-band equalization that allows a very fine level of control on the tone of the augmented electronic acoustic harmonium.

Further, the augmented electronic acoustic harmonium produces serial output from the microcontroller. The output may be used to control visuals that change with the parameters of the augmented acoustic harmonium.

Further, the augmented electronic acoustic harmonium allows custom tuning of every ‘swar’ in relation to any other ‘swar’ and this custom tuning of every ‘swar’ is important for an accompanying harmonium player.

Further, the present disclosure describes an augmented electronic acoustic harmonium which includes an electronic sound-producing mechanism in a conventional acoustic harmonium body. Further, the augmented electronic acoustic harmonium employs digital signal synthesis and processing techniques that replicate the acoustic characteristics of a dual reed harmonium. Further, the augmented electronic acoustic harmonium may include a minimal user interface and user interaction associated with the user interface to operate the electronic settings on the augmented electronic acoustic harmonium. Further, the augmented electronic acoustic harmonium may be reversibly converted to a conventional acoustic harmonium. Further, the augmented electronic acoustic harmonium employs sound control to match the musical sound to all playing environment types (such as on-stage, at home, on headphones, with or without other music in the background). Further, the augmented electronic acoustic harmonium logs the notes played by the augmented electronic acoustic harmonium, for educational, data analysis, machine learning model training, and other purposes. Further, the augmented electronic acoustic harmonium uses two pressure sensors to accurately map bellow dynamics. Further, the augmented electronic acoustic harmonium has an ultra-low-latency key response using a microcontroller, with attack and release characteristics similar to the conventional acoustic harmonium. Further, the augmented electronic acoustic harmonium allows pitch control, reed combination customization, drone tuning synchronization, volume control, pitch fine-tuning, air ventilation control, preferred key customization, and 5-band audio equalization. Further, the augmented electronic acoustic harmonium allows custom tuning for each musical note with respect to any other note. Further, the augmented electronic acoustic harmonium allows harmonium making to be a sustainable occupation for traditional harmonium makers. Further, the augmented electronic acoustic harmonium is used for producing stage visual effects based on the harmonium's parameters of the augmented electronic acoustic harmonium.

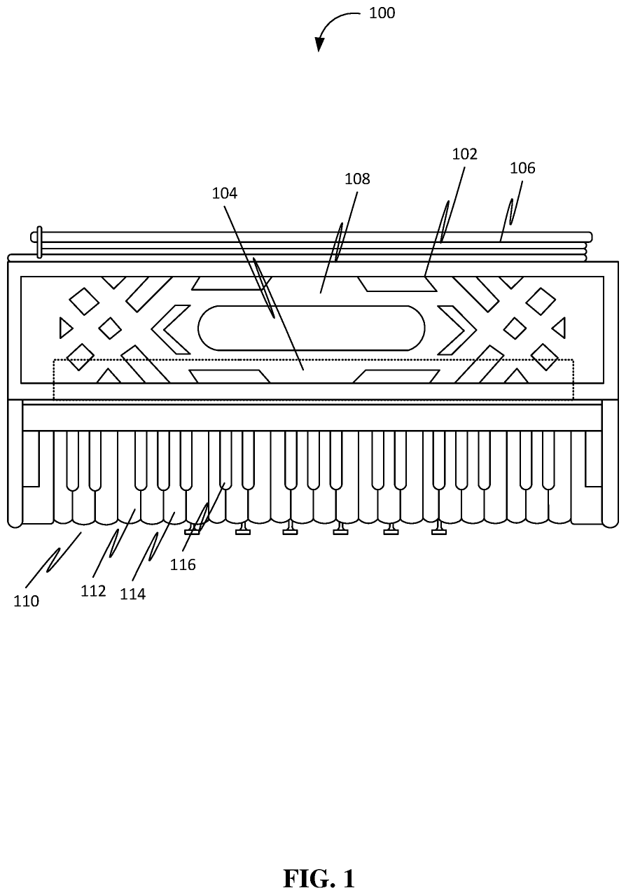

FIG. 1 is a top view of a reed musical instrument 100 for customizably producing musical sounds, in accordance with some embodiments. Accordingly, the reed musical instrument 100 may include a body 102 and a device 104. Further, the reed musical instrument 100 may include a harmonium, a dual reed harmonium, an accordion, a melodeon, a concertina, a bandoneon, a bagpipe, etc. Further, the reed musical instrument 100 may include an augmented electronic acoustic harmonium.

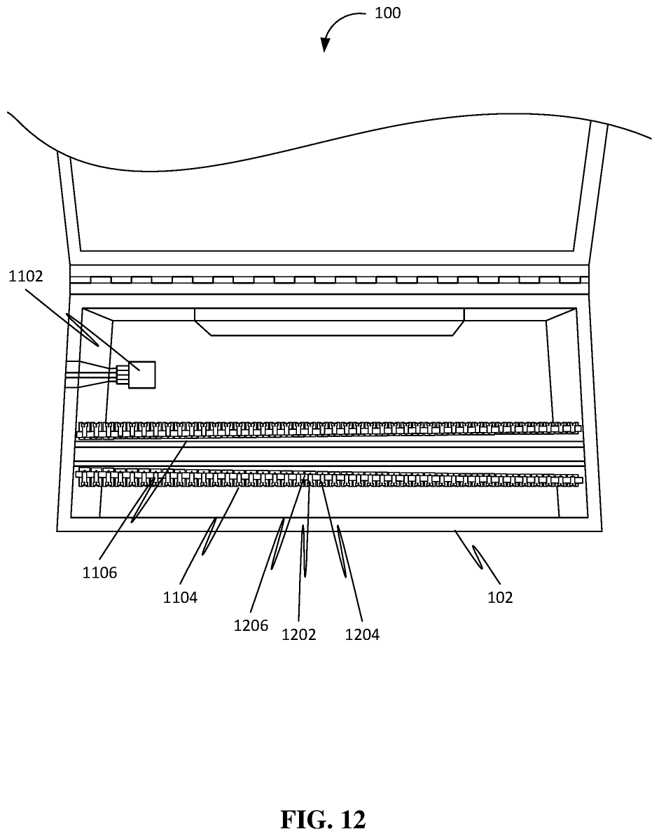

Further, the body 102 may include an airflow device 106 and at least one reed 1202-1204 (shown in FIG. 12). Further, the body 102 may include a cover 108. Further, the cover 108 may be transitionable between an opened state and a closed state. Further, the body 102 may be a housing of the reed musical instrument 100. Further, the airflow device 106 may include at least one bellow, a bag, etc. Further, the at least one reed 1202-1204 may include a reed strip having a free end and a fixed end. Further, the airflow device 106 may be configured for establishing an airflow in an interior of the body 102. Further, the airflow device 106 may be configured for receiving at least one action. Further, the establishing of the airflow may be based on the at least one action. Further, the at least one action may include a squeezing action, an expanding action, a pressing action, etc.

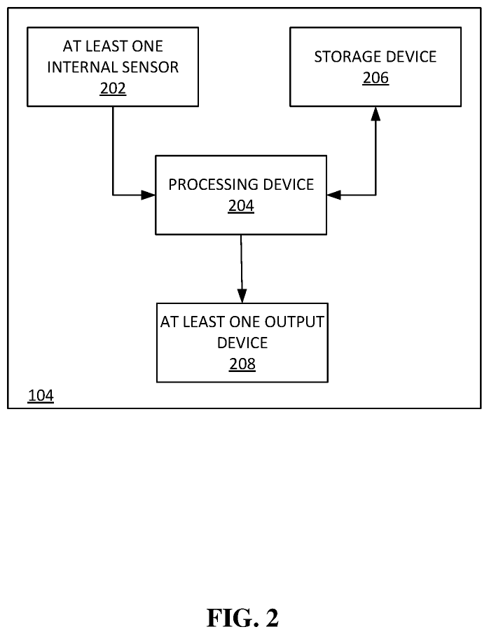

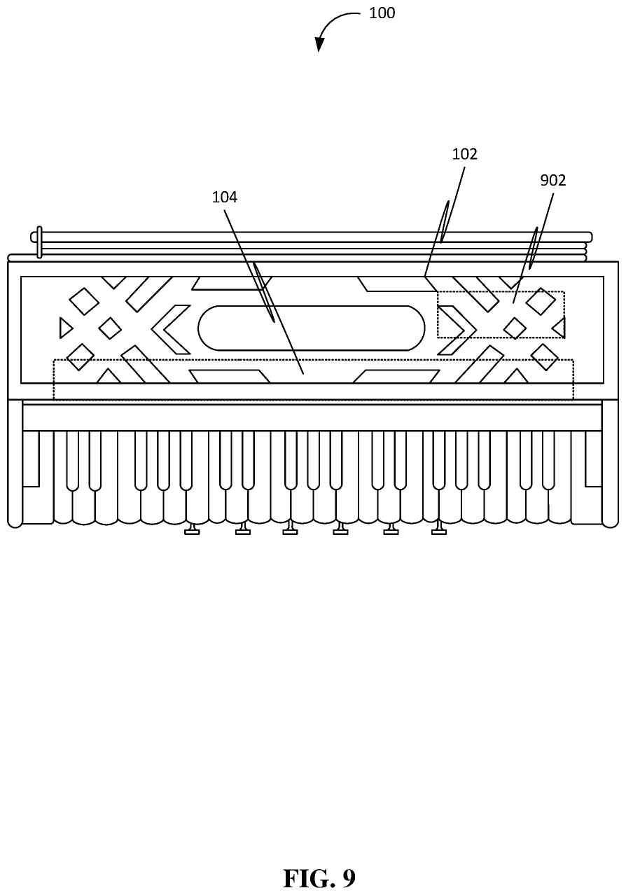

Further, the device 104 may be configured to be implemented in the body 102. Further, the device 104 may be electrically powered. Further, the device 104 may be electrically coupled with at least one power source 902, as shown in FIG. 9. Further, the at least one power source 902 may electrically power the device 104. Further, the at least one power source 902 may be disposed in the body 102. Further, the at least one power source 902 may be at least one battery, a power bank, etc. Further, the device 104 may include at least one internal sensor 202, a processing device 204, a storage device 206, and at least one output device 208, as shown in FIG. 2. Further, the at least one internal sensor 202 may be disposed in the interior of the body 102. Further, the at least one internal sensor 202 may include an air pressure sensor, an airflow sensor, etc. Further, the at least one internal sensor 202 may be configured for detecting at least one characteristic associated with the airflow. Further, the at least one characteristic may include an air pressure, an air volume, etc., of the airflow established in the interior of the body 102. Further, the processing device 204 may be communicatively coupled the at least one internal sensor 202. Further, the processing device 204 may be a microcontroller of a Teensy board. Further, the processing device 204 may be configured for generating an airflow information based on the detecting of the at least one characteristic associated with the airflow in the interior of the body 102. Further, the airflow information maps the at least one action of the airflow device 106. Further, the airflow information may be associated with a change in the air pressure in the interior of the body 102. Further, the processing device 204 may be configured for synthesizing at least one musical sound using at least one reed data associated with the at least one reed 1202-1204 based on the airflow information and at least one customization information. Further, the at least one reed data represents at least one acoustic model of at least one sound produced by the at least one reed 1202-1204. Further, the at least one customization information may include at least one modification in at least one music producing parameter of the at least one reed 1202-1204. Further, the at least one music producing parameter may include a pitch, a tone, a timbre, a frequency, a waveform, a harmonics, a volume, a musical note, etc. Further, the storage device 206 may be communicatively coupled with the processing device 204. Further, the storage device 206 may be configured for storing the at least one reed data. Further, the at least one output device 208 may be communicatively coupled with the processing device 204. Further, the at least one output device 208 may be configured for producing the at least one musical sound based on the synthesizing of the at least one musical sound. Further, the at least one output device 208 may include a speaker, a stereo speaker, two speakers, etc.

Further, in some embodiments, the at least one reed 1202-1204 may be blockable using at least one blocking element 1206 (shown in FIG. 12). Further, the blocking of the at least one reed 1202-1204 prevents the at least one reed 1202-1204 from producing a musical sound based on the establishing of the airflow in the interior of the body 102. Further, the at least one reed 1202-1204 produces the musical sound based on a vibration of the reed strip. Further, the at least one blocking element 1206 prevents the vibration of the reed strip. Further, the at least one blocking element 1206 may be placed under the reed strip near the free end of the reed strip. Further, the at least one blocking element 1206 may be a piece of paper, a strip of paper, etc.

Further, in some embodiments, the at least one reed 1202-1204 produces a musical sound based on the establishing of the airflow in the interior of the body 102. Further, the producing of the musical sound and the producing of the at least one musical sound allows a comparison of the musical sound and the at least one musical sound for facilitating tuning of the at least one musical sound based on the at least one customization information.

Further, in some embodiments, the at least one reed 1202-1204 produces a musical sound based on the establishing of the airflow in the interior of the body 102. Further, the at least one customization information may include at least one delay information associated with at least one delay in the synthesizing of the at least one musical sound after the producing of the musical sound by the at least one reed 1202-1204. Further, the at least one delay may include a time delay, a time duration, etc. Further, the synthesizing of the at least one musical sound may include generating the at least one musical sound with the at least one delay based on the at least one delay information.

Further, in some embodiments, the at least one output device 208 may include at least two speakers. Further, a first speaker of the at least two speakers may be associated with a first channel and a second speaker of the at least two speakers may be associated with a second channel. Further, the at least one musical sound may include a first musical sound associated with the first channel and a second musical sound associated with the second channel. Further, the at least one reed data may include at least one first reed data associated with the first channel and at least one second reed data associated with the second channel. Further, the synthesizing of the at least one musical sound may include generating the first musical sound and the second musical sound by varying a phase of at least one of the first musical sound and the second musical sound based on the at least one first reed data, the at least one second reed data and the airflow information. Further, the producing of the at least one musical sound may include producing the first musical sound by the first speaker associated with the first channel and producing the second musical sound by the second speaker associated with the second channel.

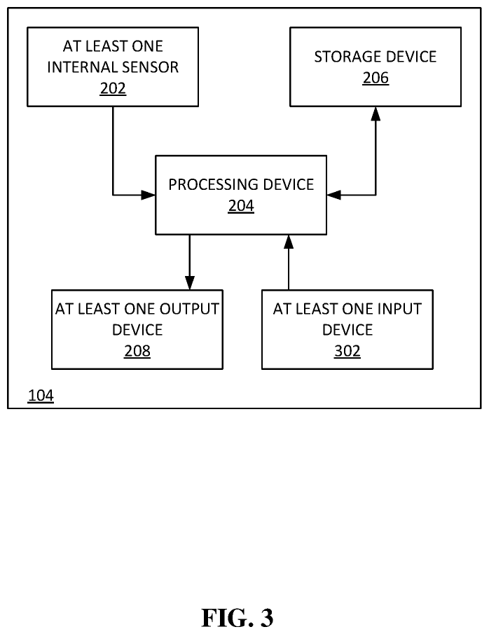

Further, in some embodiments, the device 104 may include at least one input device 302, as shown in FIG. 3. Further, the at least one input device 302 may include at least one switch. Further, the at least one switch may include three switches. Further, the at least one input device 302 may be communicatively coupled with the processing device 204. Further, the at least one input device 302 may be configured for receiving at least one input from at least one user. Further, the at least one input may include a pressing action receivable on each of the at least one switch. Further, the processing device 204 may be configured for generating the at least one customization information based on the at least one input. Further, the synthesizing of the at least one musical sound using the at least one reed data may be based on the generating of the at least one customization information.

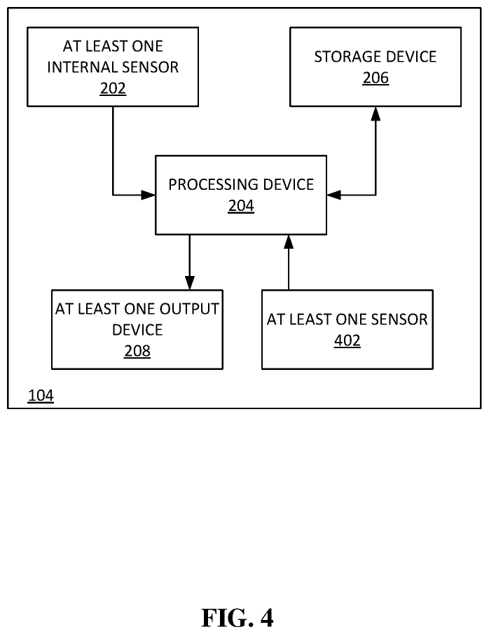

Further, in some embodiments, the device 104 may include at least one sensor 402, as shown in FIG. 4. Further, the at least one sensor 402 may be communicatively coupled with the processing device 204. Further, the at least one sensor 402 may be configured for detecting at least one musical sound characteristic of at least one external musical sound associated with an environment of the reed musical instrument 100. Further, the at least one musical sound characteristic may include a pitch, a volume, a timbre, a texture, a musical note, a tone, etc. Further, the at least one external musical sound may be produced by at least one device (speaker), at least one musical instrument (such as tanpura), etc. Further, the at least one musical instrument may be a drone instrument. Further, the at least one sensor 402 may include a microphone, an acoustic sensor, etc. Further, the processing device 204 may be configured for generating the at least one customization information based on the detecting of the at least one musical sound characteristic. Further, the generating of the at least one customization information may include determining at least one value for the at least one music producing parameter based on the at least one musical sound characteristic. Further, the synthesizing of the at least one musical sound using the at least one reed data may be based on the generating of the at least one customization information.

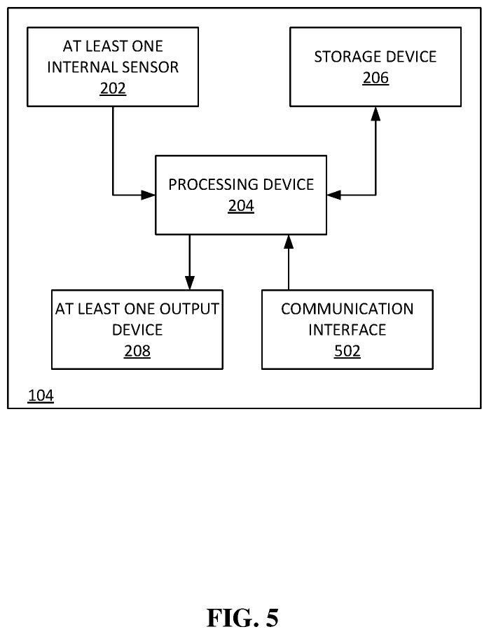

Further, in some embodiments, the processing device 204 may be configured for logging a playing of one or more musical notes based on the synthesizing of the at least one musical sound. Further, the processing device 204 may be configured for generating at least one playing information based on the logging. Further, the device 104 may include at least one communication interface 502, as shown in FIG. 5. Further, the at least one communication interface 502 may be communicatively coupled with the processing device 204. Further, the at least one communication interface 502 may be configured for transmitting the at least one playing information to at least one user device. Further, the at least one user device may include a client device, a computing device, a storage device, etc. Further, the transmitting of the at least one playing information may include transmitting the at least one playing information over at least one of a wired communication channel and a wireless communication channel.

Further, in some embodiments, the at least one reed data may include at least one waveform associated with the at least one reed 1202-1204. Further, the at least one waveform may include a variable triangle waveform with at least one frequency. Further, the synthesizing of the at least one musical sound using the at least one reed data may include modifying each of at least one waveform comprised in each of the at least one reed data through each of at least one envelope based on the airflow information and the at least one customization information. Further, the at least one envelope may be associated with at least one phase. Further, at least one of an attack phase and a release phase of the at least one phase may be modified based on the airflow information and the modifying of at least one of the attack phase and the release phase modifies the at least one waveform. Further, the synthesizing of the at least one musical sound using the at least one reed data may include generating a modified waveform for each of the at least one waveform based on the modifying. Further, the synthesizing of the at least one musical sound using the at least one reed data may include performing at least one operation on the modified waveform for each of the at least one waveform based on the at least one customization information. Further, the at least one operation may include performing a filtering operation using at least one audio filter, an equalization operation using an N-band equalizer, an amplitude adjustment, etc. Further, the synthesizing of the at least one musical sound using the at least one reed data may include generating a dual channel musical sound signal based on the performing of the at least one operation. Further, the at least one musical sound may include the dual channel musical sound signal.

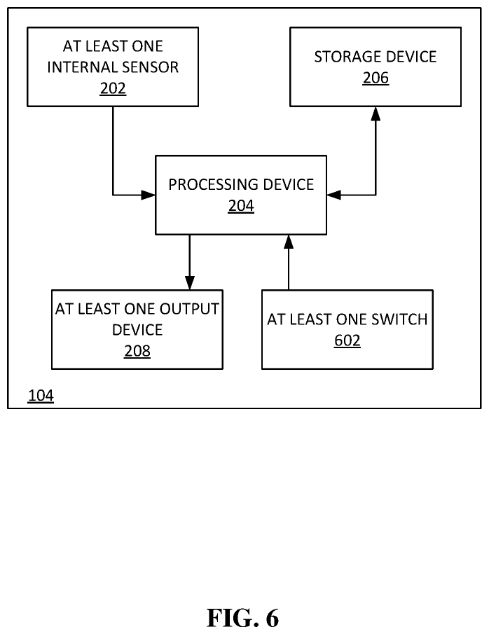

Further, in an embodiment, the body 102 may include at least one key 112-116 corresponding to the at least one reed 1202-1204. Further, the at least one key 112-116 may be comprised in a keyboard 110 of the reed musical instrument 100. Further, the body 102 may include the keyboard 110. Further, the device 104 may include at least one switch 602, as shown in FIG. 6. Further, the at least one switch 602 may be configured for detecting at least one playing action corresponding to the at least one key 112-116. Further, the at least one playing action may include a pressing, a releasing, etc. of the at least one key 112-116. Further, the at least one switch 602 may be communicatively coupled with the processing device 204. Further, the processing device 204 may be configured for generating at least one key playing information based on the detecting of the at least one playing action. Further, the synthesizing of the at least one musical sound using the at least one reed data may be based on the at least one key playing information.

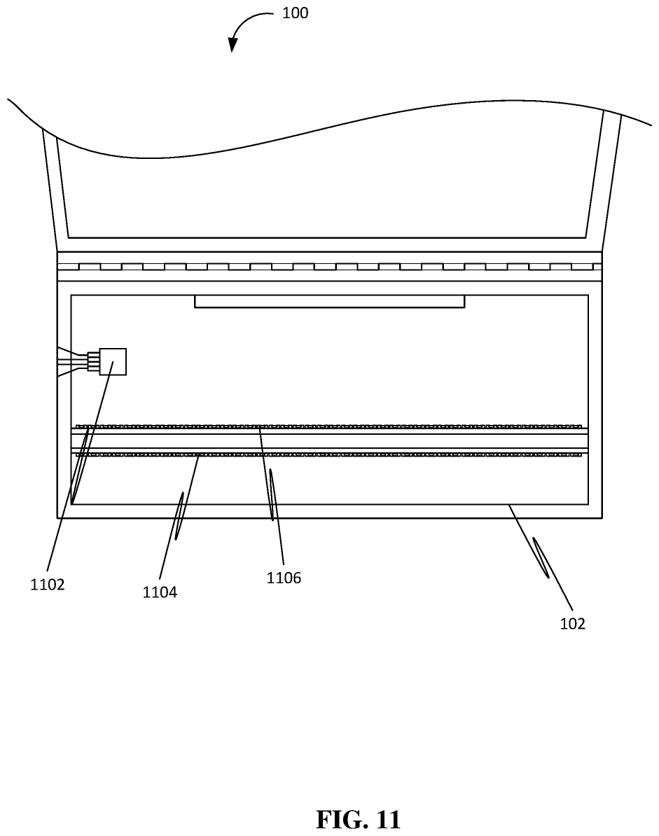

Further, in an embodiment, the synthesizing of the at least one musical sound using the at least one reed data may include identifying at least two reed banks 1104-1106 (shown in FIG. 11) and at least one of a plurality of reeds from each of the at least two reed banks 1104-1106 corresponding to the at least one key 112-116 based on the at least one customization information and the at least one key playing information. Further, the at least one customization information may include an indication of the at least two reed banks 1104-1106. Further, each of at least two reed banks 1104-1106 corresponds to a specific sounding set of reeds. Further, the specific sounding set of reeds may be male, female, bass, tenor, etc. Further, each of at least two reed banks 1104-1106 corresponds to a reed bank type. Further, the reed bank type may include a nar type, a kharaj type, etc. Further, the synthesizing of the at least one musical sound using the at least one reed data may include identifying the at least one reed data of at least one of the plurality of reeds from each of the at least two reed banks 1104-1106 based on the identifying of the at least two reed banks 1104-1106 and at least one of the plurality of reeds from each of the at least two reed banks 1104-1106. Further, the modifying of each of the at least one waveform comprised in each of the at least one reed data may be based on the identifying of the at least one reed data.

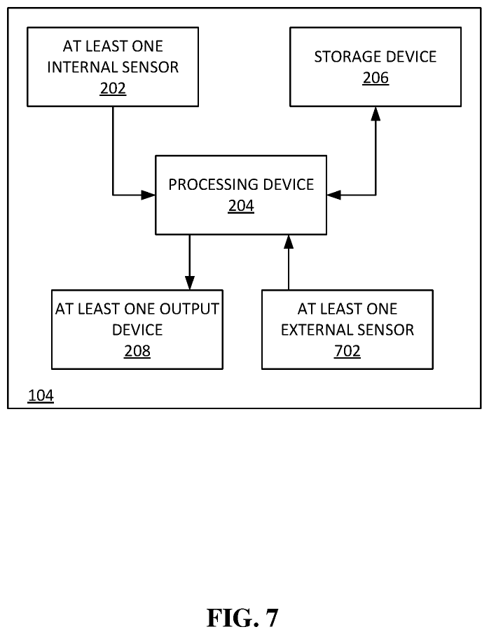

Further, in some embodiments, the device 104 may include at least one external sensor 702, as shown in FIG. 7. Further, the at least one external sensor 702 may be disposed in an exterior of the body 102. Further, the at least one external sensor 702 may be communicatively coupled with the processing device 204. Further, the at least one external sensor 702 may be configured for detecting at least one characteristic of air associated with the exterior of the body 102. Further, the at least one external sensor 702 may include an air pressure sensor, an airflow sensor, etc. Further, the at least one characteristic may include an air pressure, etc. Further, the processing device 204 may be configured for determining at least one relative characteristic based on the detecting of the at least one characteristic of the air associated with the exterior of the body 102 and the detecting of the at least one characteristic of the airflow in the interior of the body 102. Further, the at least one relative characteristic may include a pressure difference. Further, the generating of the airflow information may be based on the determining of the at least one relative characteristic.

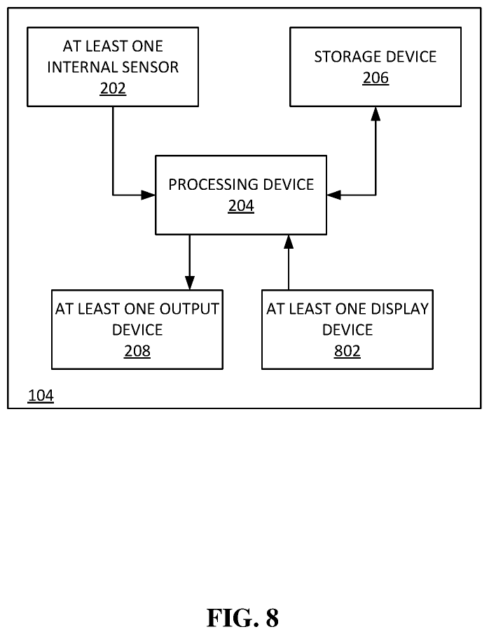

Further, in some embodiments, the at least one customization information may include at least one value of at least one parameter for customizing the musical sound. Further, the at least one parameter may include the at least one music producing parameter. Further, the device 104 may include at least one display device 802, as shown in FIG. 8. Further, the at least one display device 802 may be communicatively coupled with the processing device 204. Further, the at least one display device 802 may be configured for displaying the at least one value and the at least one parameter. Further, the at least one display device 802 may include a display screen, a user interface device, etc.

Further, in an embodiment, the at least one parameter may include at least one of a pitch, a reed combination, a drone tune, a volume, a pitch fine-tune, an air ventilation, a key preference, and an N-band audio equalization.

Further, in some embodiments, the at least one customization information may include a tuning information associated with a tuning of a musical note associated with the reed musical instrument 100 with respect to at least one of a plurality of musical notes associated with the reed musical instrument 100.

Further, in some embodiments, the device 104 may be removably implemented in the body 102.

Further, in some embodiments, the at least one blocking element 1206 may be removably implemented in the at least one reed 1202-1204 for removably blocking the at least one reed 1202-1204. Further, the removably implementing may include removably placing, removably inserting, removably disposing, etc.

FIG. 2 is a block diagram of the device 104 of the reed musical instrument 100, in accordance with some embodiments.

FIG. 3 is a block diagram of the device 104 of the reed musical instrument 100, in accordance with some embodiments.

FIG. 4 is a block diagram of the device 104 of the reed musical instrument 100, in accordance with some embodiments.

FIG. 5 is a block diagram of the device 104 of the reed musical instrument 100, in accordance with some embodiments.

FIG. 6 is a block diagram of the device 104 of the reed musical instrument 100, in accordance with some embodiments.

FIG. 7 is a block diagram of the device 104 of the reed musical instrument 100, in accordance with some embodiments.

FIG. 8 is a block diagram of the device 104 of the reed musical instrument 100, in accordance with some embodiments.

FIG. 9 is a top view of the reed musical instrument 100, in accordance with some embodiments.

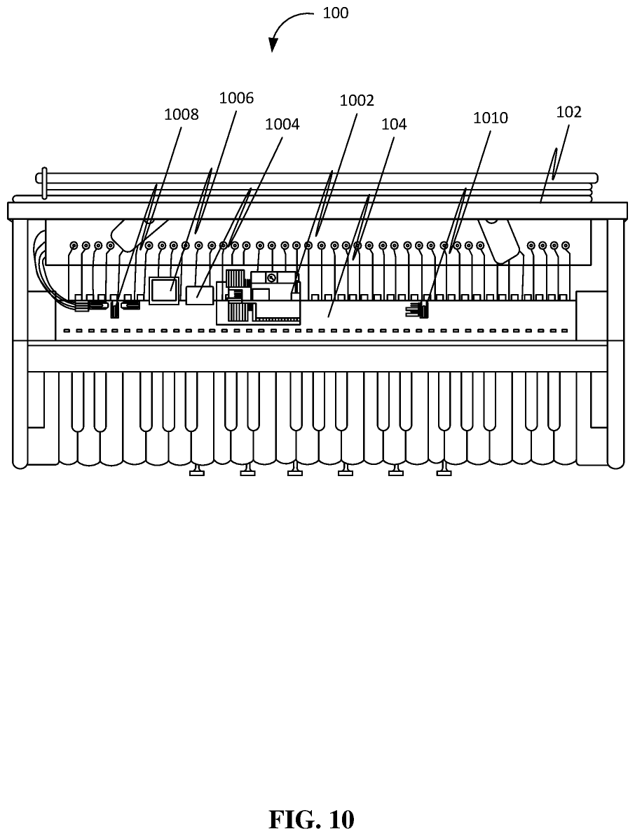

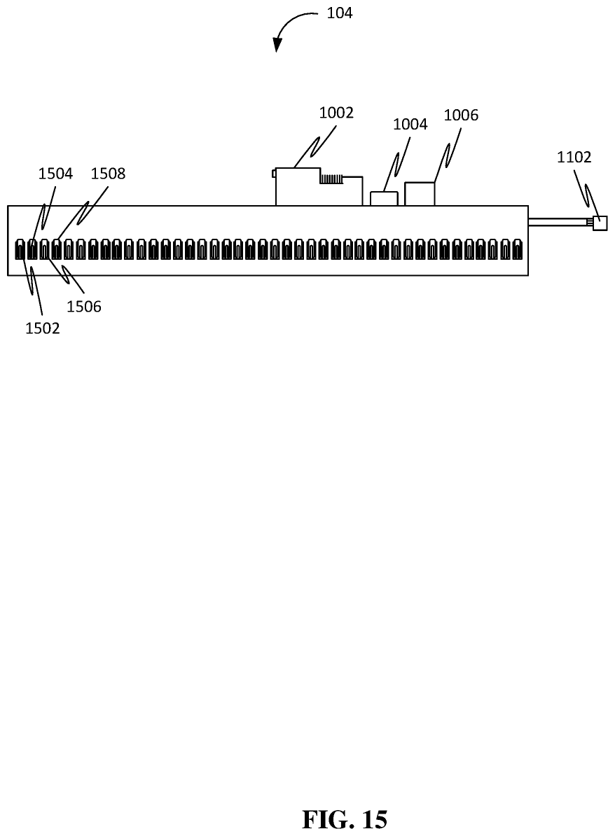

FIG. 10 is a top view of the reed musical instrument 100 with the cover 108 in the opened state, in accordance with some embodiments. Further, the device 104 may be comprised in a printed circuit board (PCB). Further, the PCB may include a teensy board 1002, an external sensor 1004, a display 1006, at least one input switch 1008, a power switch 1010, an internal sensor 1102 (shown in FIG. 11), and a plurality of key switches 1502-1508 (shown in FIG. 15). Further, the teensy board 1002 may include an audio shield. Further, the audio shield may be an audio adaptor. Further, the teensy board 1002 may include a microcontroller. Further, the microcontroller may correspond to the processing device 204, the at least one input switch 1008 may correspond to the at least one input device 302, the plurality of key switches 1502-1508 may correspond to the at least one switch 602.

FIG. 11 is a partial internal view of the reed musical instrument 100, in accordance with some embodiments.

FIG. 12 is a partial internal view of the reed musical instrument 100, in accordance with some embodiments.

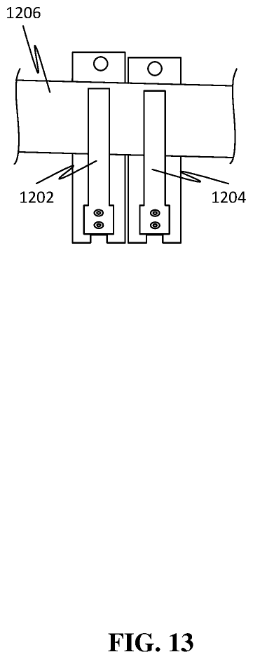

FIG. 13 is a partial enlarged view of the at least one reed 1202-1204 of the reed musical instrument 100, in accordance with some embodiments.

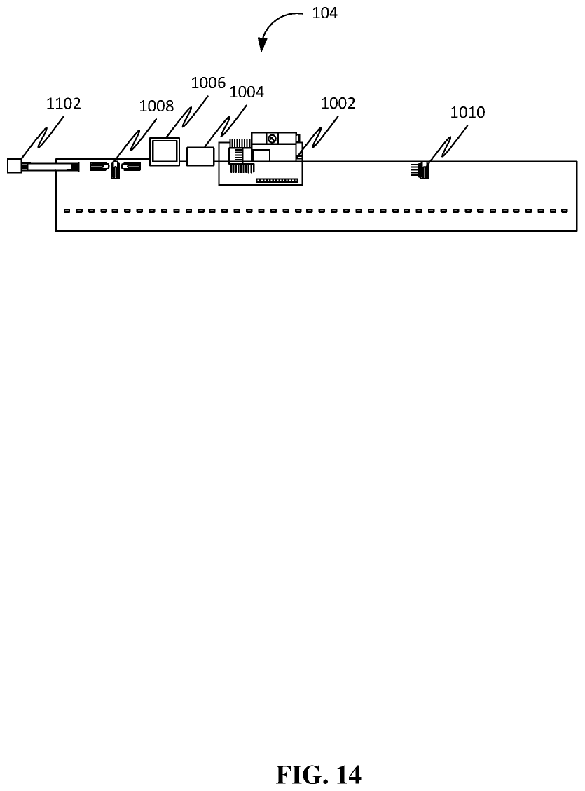

FIG. 14 is a front view of the device 104 of the reed musical instrument 100, in accordance with some embodiments.

FIG. 15 is a rear view of the device 104 of the reed musical instrument 100, in accordance with some embodiments.

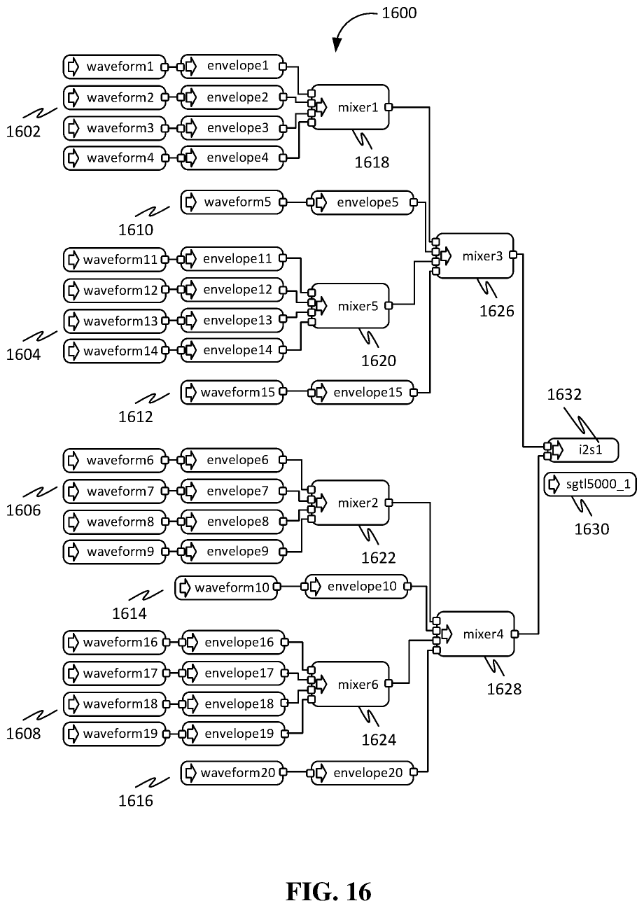

FIG. 16 is a flow diagram of a process 1600 for synthesizing the musical sound using the reed musical instrument 100, in accordance with some embodiments. Further, the process 1600 may be associated with the synthesizing of the musical sound using at least two reed banks. Further, the process 1600 may include providing a number of sets of waveforms and envelopes 1602-1608. Further, the number of sets of waveforms and envelopes 1602-1608 may be equally divided for two channels. Further, at least one of the number of sets of waveforms and envelopes 1602-1608 may be used based on a reed combination. Further, a number of waveforms and envelopes in each of the number of sets of waveforms and envelopes 1602-1608 may correspond to a number of keys played in the reed musical instrument. Further, the process 1600 may include providing a number of buffer waveforms and envelopes 1610-1616. Further, each of the number of buffer waveforms and envelopes 1610-1616 may be provided after each of the number of sets of waveforms and envelopes 1602-1608. Further, an output from the number of waveforms and envelopes in each of the number of sets of waveforms and envelopes (1602-1608) may be mixed using a mixer (1618, 1620, 1622, and 1624). Further, an output from the mixer ((1618 and 1620) and (1622 and 1624)) and an output from each of the number of buffer waveforms and envelopes (1610-1612 and 1614-1616) may be mixed using a second mixer (1626 and 1628) for each of the two channels. Further, at least one sound processing operation may be performed on an output from the second mixer corresponding to each of the two channels using a stereo codec 1630. Further, the stereo codec may be SGTL5000. Further, the at least one sound processing operation implementing sound equalization, amplitude modification, etc. Further, the output from the second mixer (1626-1628) corresponding to each of the two channels may be fed into an interface 1632. Further, the interface 1632 may be an I2S interface.

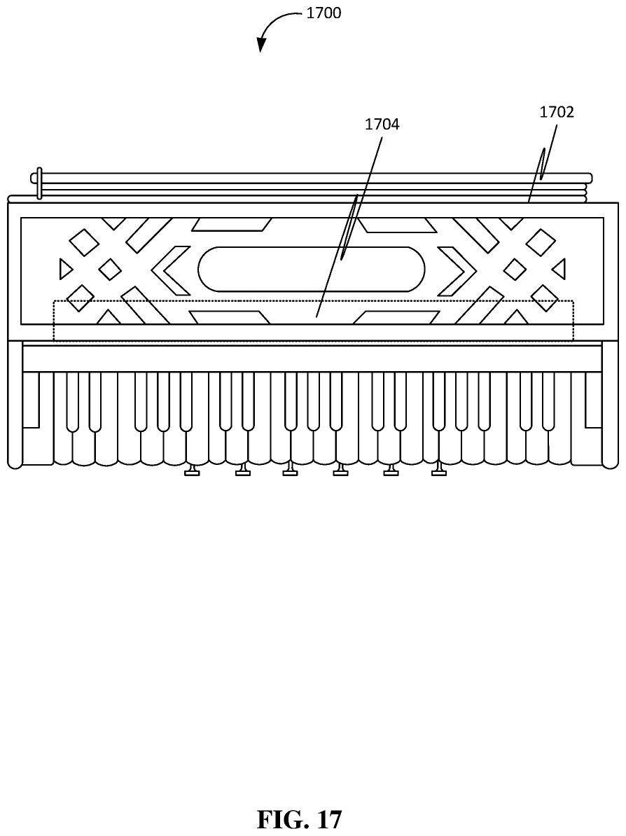

FIG. 17 is a top view of a reed musical instrument 1700 for customizably producing musical sounds, in accordance with some embodiments. Accordingly, the reed musical instrument 1700 may include a body 1702 and a device 1704.

Further, the body 1702 may include an airflow device, at least one reed, and at least one key. Further, the airflow device may be configured for establishing an airflow in an interior of the body 1702. Further, the at least one key corresponds to the at least one reed.

Further, the device 1704 may be configured to be implemented in the body 1702. Further, the device 1704 may include at least one switch 1810, at least one internal sensor 1802, a processing device 1804, a storage device 1806, and at least one output device 1808. Further, the at least one switch 1810 may be configured for detecting at least one playing action corresponding to the at least one key. Further, the at least one internal sensor 1802 may be disposed in the interior of the body 1702. Further, the at least one internal sensor 1802 may be configured for detecting at least one characteristic associated with the airflow. Further, the processing device 1804 may be communicatively coupled the at least one internal sensor 1802 and the at least one switch 1810. Further, the processing device 1804 may be configured for generating at least one key playing information based on the detecting of the at least one playing action. Further, the processing device 1804 may be configured for generating an airflow information based on the detecting of the at least one characteristic associated with the airflow in the interior of the body 1702. Further, the processing device 1804 may be configured for synthesizing at least one musical sound using at least one reed data associated with the at least one reed based on the at least one key playing information, the airflow information, and at least one customization information. Further, the storage device 1806 may be communicatively coupled with the processing device 1804. Further, the storage device 1806 may be configured for storing the at least one reed data. Further, the at least one output device 1808 may be communicatively coupled with the processing device 1804. Further, the at least one output device 1808 may be configured for producing the at least one musical sound based on the synthesizing of the at least one musical sound.

Further, in some embodiments, the device 1704 may include at least one input device. Further, the at least one input device may be communicatively coupled with the processing device 1804. Further, the at least one input device may be configured for receiving at least one input from at least one user. Further, the processing device 1804 may be further configured for generating the at least one customization information based on the at least one input. Further, the synthesizing of the at least one musical sound using the at least one reed data may be further based on the generating of the at least one customization information.

Further, in some embodiments, the at least one customization information may include at least one value of at least one parameter for customizing the musical sound. Further, the device 1704 further may include at least one display device. Further, the at least one display device may be communicatively coupled with the processing device 1804. Further, the at least one display device may be configured for displaying the at least one value and the at least one parameter.

Further, in an embodiment, the at least one parameter may include at least one of a pitch, a reed combination, a drone tune, a volume, a pitch fine-tune, an air ventilation, a key preference, and an N-band audio equalization.

Further, in some embodiments, the device 1704 may be removably implemented in the body 1702.

Further, in some embodiments, the at least one blocking element may be removably implemented in the at least one set of reeds for removably blocking the at least one reed.

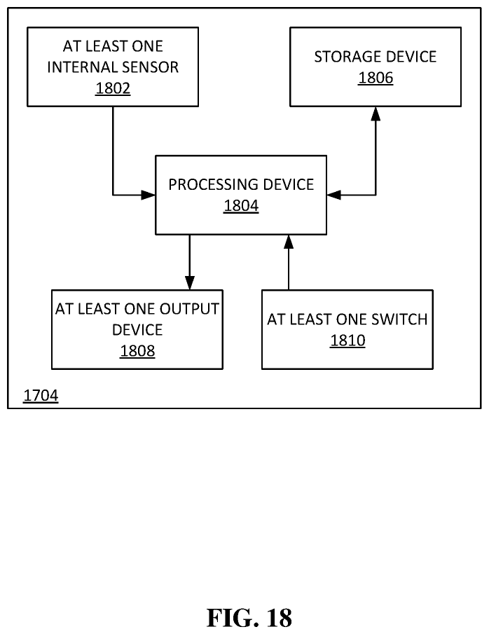

FIG. 18 is a block diagram of the device 1704 of the reed musical instrument 1700, in accordance with some embodiments.

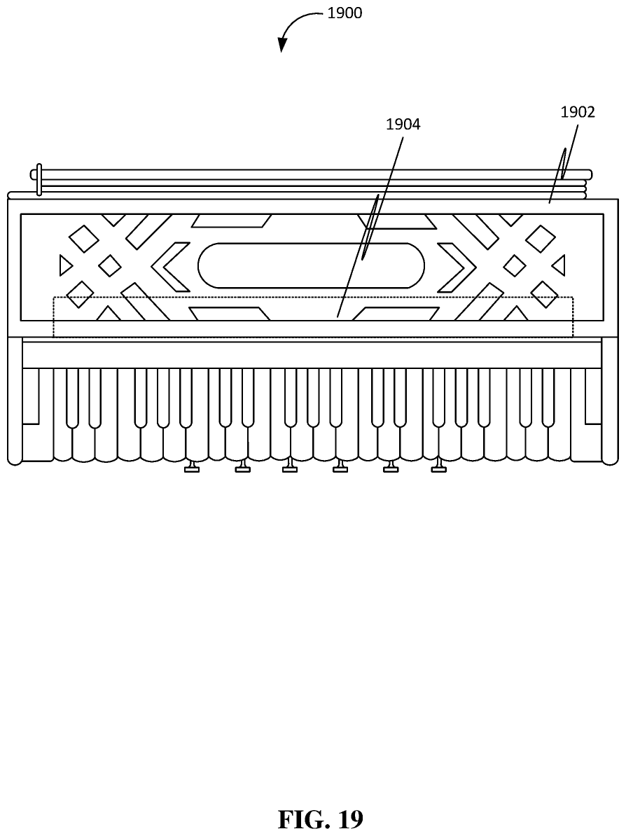

FIG. 19 is a top view of a reed musical instrument 1900 for customizably producing musical sounds, in accordance with some embodiments. Accordingly, the reed musical instrument 1900 may include a body 1902 and a device 1904.

Further, the body 1902 may include an airflow device, at least one reed, and at least one key. Further, the airflow device may be configured for establishing an airflow in an interior of the body 1902. Further, the at least one key corresponds to the at least one reed.

Further, the device 1904 may be configured to be implemented in the body 1902. Further, the device 1904 may include at least one switch 2010, at least one internal sensor 2002, at least one external sensor 2012, a processing device 2004, a storage device 2006, and at least one output device 2008. Further, the at least one switch 2010 may be configured for detecting at least one playing action corresponding to the at least one key. Further, the at least one internal sensor 2002 may be disposed in the interior of the body 1902. Further, the at least one internal sensor 2002 may be configured for detecting at least one characteristic associated with the airflow. Further, the at least one external sensor 2012 may be disposed in an exterior of the body 1902. Further, the at least one external sensor 2012 may be configured for detecting at least one characteristic of air associated with the exterior of the body 1902. Further, the processing device 2004 may be communicatively coupled the at least one internal sensor 2002, the at least one external sensor 2012, and the at least one switch 2010. Further, the processing device 2004 may be configured for generating at least one key playing information based on the detecting of the at least one playing action. Further, the processing device 2004 may be configured for determining at least one relative characteristic based on the detecting of the at least one characteristic of the air associated with the exterior of the body 1902 and the detecting of the at least one characteristic of the airflow in the interior of the body 1902. Further, the processing device 2004 may be configured for generating an airflow information based on the determining. Further, the processing device 2004 may be configured for synthesizing at least one musical sound using at least one reed data associated with the at least one reed based on the at least one key playing information, the airflow information, and at least one customization information. Further, the storage device 2006 may be communicatively coupled with the processing device 2004. Further, the storage device 2006 may be configured for storing the at least one reed data. Further, the at least one output device 2008 may be communicatively coupled with the processing device 2004. Further, the at least one output device 2008 may be configured for producing the at least one musical sound based on the synthesizing of the at least one musical sound.

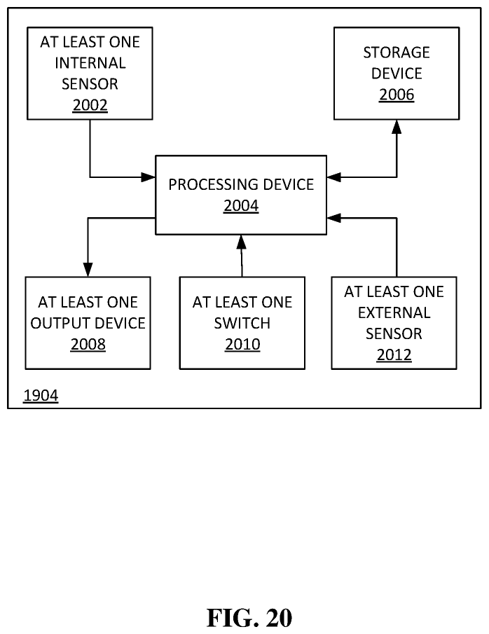

FIG. 20 is a block diagram of the device 1904 of the reed musical instrument 1900, in accordance with some embodiments.

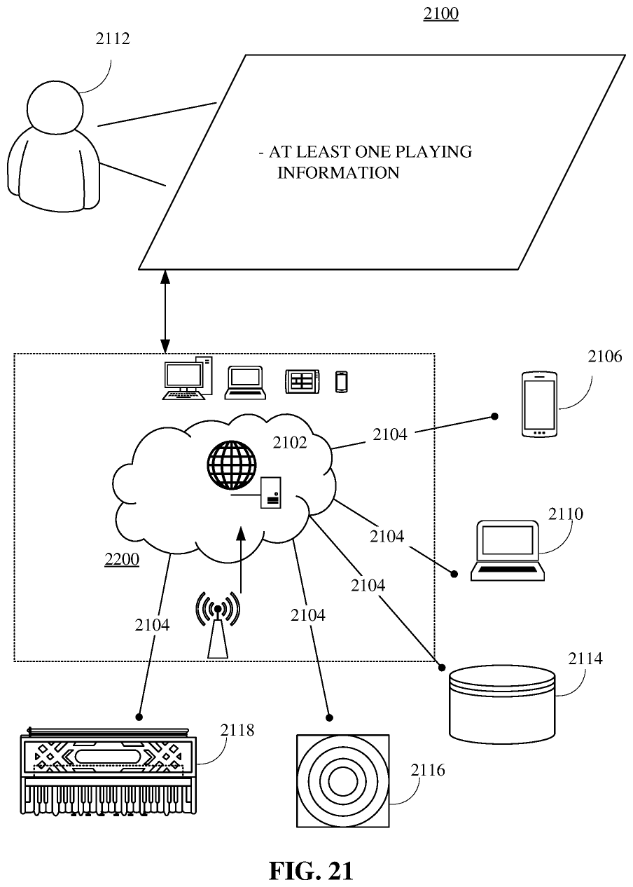

FIG. 21 is an illustration of an online platform 2100 consistent with various embodiments of the present disclosure. By way of non-limiting example, the online platform 2100 to customizably producing musical sounds using a reed musical instrument may be hosted on a centralized server 2102, such as, for example, a cloud computing service. The centralized server 2102 may communicate with other network entities, such as, for example, a mobile device 2106 (such as a smartphone, a laptop, a tablet computer, etc.), other electronic devices 2110 (such as desktop computers, server computers, etc.), databases 2114, sensors 2116, and a reed musical instrument 2118 (such as the reed musical instrument 100, the reed musical instrument 1700, the reed musical instrument 1900, etc.) over a communication network 2104, such as, but not limited to, the Internet. Further, users of the online platform 2100 may include relevant parties such as, but not limited to, end-users, administrators, service providers, service consumers, and so on. Accordingly, in some instances, electronic devices operated by the one or more relevant parties may be in communication with the platform.

A user 2112, such as the one or more relevant parties, may access online platform 2100 through a web based software application or browser. The web based software application may be embodied as, for example, but not be limited to, a website, a web application, a desktop application, and a mobile application compatible with a computing device 2200.

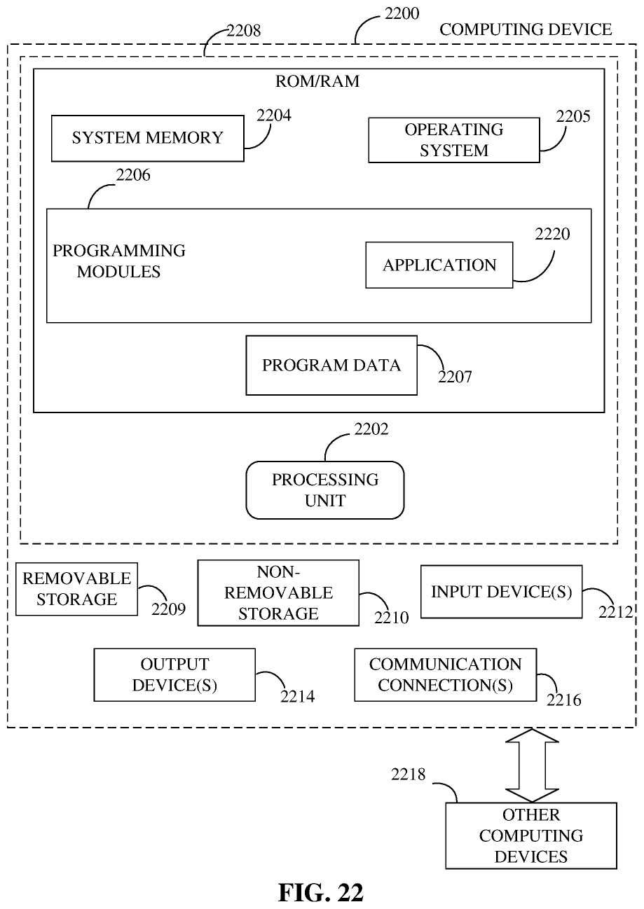

With reference to FIG. 22, a system consistent with an embodiment of the disclosure may include a computing device or cloud service, such as computing device 2200. In a basic configuration, computing device 2200 may include at least one processing unit 2202 and a system memory 2204. Depending on the configuration and type of computing device, system memory 2204 may comprise, but is not limited to, volatile (e.g. random-access memory (RAM)), non-volatile (e.g. read-only memory (ROM)), flash memory, or any combination. System memory 2204 may include operating system 2205, one or more programming modules 2206, and may include a program data 2207. Operating system 2205, for example, may be suitable for controlling computing device 2200′s operation. In one embodiment, programming modules 2206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

Computing device 2200 may have additional features or functionality. For example, computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and non-volatile, removable and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2200. Any such computer storage media may be part of device 2200. Computing device 2200 may also have input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used.

Computing device 2200 may also contain a communication connection 2216 that may allow device 2200 to communicate with other computing devices 2218, such as over a network in a distributed computing environment, for example, an intranet or the Internet. Communication connection 2216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2204, including operating system 2205. While executing on processing unit 2202, programming modules 2206 (e.g., application 2220 such as a media player) may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

According to some aspects a reed musical instrument for customizably producing musical sounds comprising of a body, an airflow device, and at least one reed, characterized by: the at least one reed including at least one blocking element, wherein the at least one blocking element blocks the at least one set of reeds; at least one internal sensor disposed in the interior of the body, wherein the at least one internal sensor is configured for detecting at least one characteristic associated with the airflow; a processing device communicatively coupled the at least one internal sensor, wherein the processing device is configured for: generating an airflow information based on the detecting of the at least one characteristic associated with the airflow in the interior of the body; and synthesizing at least one musical sound using at least one reed data associated with the at least one reed based on the airflow information and at least one customization information; a storage device communicatively coupled with the processing device, wherein the storage device is configured for storing the at least one reed data; and at least one output device communicatively coupled with the processing device, wherein the at least one output device is configured for producing the at least one musical sound based on the synthesizing of the at least one musical sound.

Further, according to some aspects, wherein the reed musical instrument comprises at least one input device, wherein the at least one input device is communicatively coupled with the processing device, wherein the at least one input device is configured for receiving at least one input from at least one user, wherein the processing device is further configured for generating the at least one customization information based on the at least one input, wherein the synthesizing of the at least one musical sound using the at least one reed data is further based on the generating of the at least one customization information.

Further, according to some aspects, wherein the reed musical instrument comprises at least one sensor, wherein the at least one sensor is communicatively coupled with the processing device, wherein the at least one sensor is configured for detecting at least one musical sound characteristic of at least one external musical sound associated with an environment of the reed musical instrument, wherein the processing device is further configured for generating the at least one customization information based on the detecting of the at least one musical sound characteristic, wherein the synthesizing of the at least one musical sound using the at least one reed data is further based on the generating of the at least one customization information.

Further, according to some aspects, wherein the processing device is further configured for: logging a playing of one or more musical notes based on the synthesizing of the at least one musical sound; and generating at least one playing information based on the logging, wherein the reed musical instrument comprises at least one communication interface, wherein the at least one communication interface is communicatively coupled with the processing device, wherein the at least one communication interface is configured for transmitting the at least one playing information to at least one user device.

Further, according to some aspects, wherein the at least one reed data comprises at least one waveform associated with the at least one reed, wherein the synthesizing of the at least one musical sound using the at least one reed data comprises: modifying each of at least one waveform comprised in each of the at least one reed data through each of at least one envelope based on the airflow information and the at least one customization information; generating a modified waveform for each of the at least one waveform based on the modifying; performing at least one operation on the modified waveform for each of the at least one waveform based on the at least one customization information; and generating a dual channel musical sound signal based on the performing of the at least one operation, wherein the at least one musical sound comprises the dual channel musical sound signal.

Further, according to an aspect, wherein the reed musical instrument comprises at least one key corresponding to the at least one reed and at least one switch, wherein the at least one switch is configured for detecting at least one playing action corresponding to the at least one key, wherein the at least one switch is communicatively coupled with the processing device, wherein the processing device is further configured for generating at least one key playing information based on the detecting of the at least one playing action, wherein the synthesizing of the at least one musical sound using the at least one reed data is further based on the at least one key playing information.

Further, according to an aspect, wherein the synthesizing of the at least one musical sound using the at least one reed data comprises: identifying at least two reed banks and at least one of a plurality of reeds from each of the at least two reed banks corresponding to the at least one key based on the at least one customization information and the at least one key playing information; and identifying the at least one reed data of at least one of the plurality of reeds from each of the at least two reed banks based on the identifying of the at least two reed banks and at least one of the plurality of reeds from each of the at least two reed banks, wherein the modifying of each of the at least one waveform comprised in each of the at least one reed data is based on the identifying of the at least one reed data.

Further, according to some aspects, wherein the reed musical instrument comprises at least one external sensor, wherein the at least one external sensor is disposed in an exterior of the body, wherein the at least one external sensor is communicatively coupled with the processing device, wherein the at least one external sensor is configured for detecting at least one characteristic of air associated with the exterior of the body, wherein the processing device is further configured for determining at least one relative characteristic based on the detecting of the at least one characteristic of the air associated with the exterior of the body and the detecting of the at least one characteristic of the airflow in the interior of the body, wherein the generating of the airflow information is based on the determining of the at least one relative characteristic.

Further, according to some aspects, wherein the at least one customization information comprises at least one value of at least one parameter for customizing the musical sound, wherein the reed musical instrument comprises at least one display device, wherein the at least one display device is communicatively coupled with the processing device, wherein the at least one display device is configured for displaying the at least one value and the at least one parameter.

Further, according to an aspect, wherein the at least one parameter comprises at least one of a pitch, a reed combination, a drone tune, a volume, a pitch fine-tune, an air ventilation, a key preference, and an N-band audio equalization.

What is claimed is:

1. A reed musical instrument for customizably producing musical sounds, the reed musical instrument comprising:
a body comprising an airflow device and at least one reed, wherein the airflow device is configured for establishing an airflow in an interior of the body;
a device configured to be implemented in the body, wherein the device comprises:
at least one internal sensor disposed in the interior of the body, wherein the at least one internal sensor is configured for detecting at least one characteristic associated with the airflow;
a processing device communicatively coupled the at least one internal sensor, wherein the processing device is configured for:
generating an airflow information based on the detecting of the at least one characteristic associated with the airflow in the interior of the body; and
synthesizing at least one musical sound using at least one reed data associated with the at least one reed based on the airflow information and at least one customization information;
a storage device communicatively coupled with the processing device, wherein the storage device is configured for storing the at least one reed data; and
at least one output device communicatively coupled with the processing device, wherein the at least one output device is configured for producing the at least one musical sound based on the synthesizing of the at least one musical sound.

2. The reed musical instrument of claim 1, wherein the at least one reed is blockable using at least one blocking element, wherein the blocking of the at least one reed prevents the at least one reed from producing a musical sound based on the establishing of the airflow in the interior of the body.

3. The reed musical instrument of claim 1, wherein the at least one reed produces a musical sound based on the establishing of the airflow in the interior of the body, wherein the producing of the musical sound and the producing of the at least one musical sound allows a comparison of the musical sound and the at least one musical sound for facilitating tuning of the at least one musical sound based on the at least one customization information.

4. The reed musical instrument of claim 1, wherein the at least one reed produces a musical sound based on the establishing of the airflow in the interior of the body, wherein the at least one customization information comprises at least one delay information associated with at least one delay in the synthesizing of the at least one musical sound after the producing of the musical sound by the at least one reed, wherein the synthesizing of the at least one musical sound comprises generating the at least one musical sound with the at least one delay based on the at least one delay information.

5. The reed musical instrument of claim 1, wherein the at least one output device comprises at least two speakers, wherein a first speaker of the at least two speakers is associated with a first channel and a second speaker of the at least two speakers is associated with a second channel, wherein the at least one musical sound comprises a first musical sound associated with the first channel and a second musical sound associated with the second channel, wherein the at least one reed data comprises at least one first reed data associated with the first channel and at least one second reed data associated with the second channel, wherein the synthesizing of the at least one musical sound comprises generating the first musical sound and the second musical sound by varying a phase of at least one of the first musical sound and the second musical sound based on the at least one first reed data, the at least one second reed data and the airflow information, wherein the producing of the at least one musical sound comprises producing the first musical sound by the first speaker associated with the first channel and producing the second musical sound by the second speaker associated with the second channel.

6. The reed musical instrument of claim 1, wherein the device further comprises at least one input device, wherein the at least one input device is communicatively coupled with the processing device, wherein the at least one input device is configured for receiving at least one input from at least one user, wherein the processing device is further configured for generating the at least one customization information based on the at least one input, wherein the synthesizing of the at least one musical sound using the at least one reed data is further based on the generating of the at least one customization information.

7. The reed musical instrument of claim 1, wherein the device further comprises at least one sensor, wherein the at least one sensor is communicatively coupled with the processing device, wherein the at least one sensor is configured for detecting at least one musical sound characteristic of at least one external musical sound associated with an environment of the reed musical instrument, wherein the processing device is further configured for generating the at least one customization information based on the detecting of the at least one musical sound characteristic, wherein the synthesizing of the at least one musical sound using the at least one reed data is further based on the generating of the at least one customization information.

8. The reed musical instrument of claim 1, wherein the processing device is further configured for:
logging a playing of one or more musical notes based on the synthesizing of the at least one musical sound; and
generating at least one playing information based on the logging, wherein the device further comprises at least one communication interface, wherein the at least one communication interface is communicatively coupled with the processing device, wherein the at least one communication interface is configured for transmitting the at least one playing information to at least one user device.

9. The reed musical instrument of claim 1, wherein the at least one reed data comprises at least one waveform associated with the at least one reed, wherein the synthesizing of the at least one musical sound using the at least one reed data comprises:
modifying each of at least one waveform comprised in each of the at least one reed data through each of at least one envelope based on the airflow information and the at least one customization information;
generating a modified waveform for each of the at least one waveform based on the modifying;
performing at least one operation on the modified waveform for each of the at least one waveform based on the at least one customization information; and
generating a dual channel musical sound signal based on the performing of the at least one operation, wherein the at least one musical sound comprises the dual channel musical sound signal.

10. The reed musical instrument of claim 9, wherein the body comprises at least one key corresponding to the at least one reed, wherein the device further comprises at least one switch, wherein the at least one switch is configured for detecting at least one playing action corresponding to the at least one key, wherein the at least one switch is communicatively coupled with the processing device, wherein the processing device is further configured for generating at least one key playing information based on the detecting of the at least one playing action, wherein the synthesizing of the at least one musical sound using the at least one reed data is further based on the at least one key playing information.

11. The reed musical instrument of claim 10, wherein the synthesizing of the at least one musical sound using the at least one reed data comprises:
identifying at least two reed banks and at least one of a plurality of reeds from each of the at least two reed banks corresponding to the at least one key based on the at least one customization information and the at least one key playing information; and
identifying the at least one reed data of at least one of the plurality of reeds from each of the at least two reed banks based on the identifying of the at least two reed banks and at least one of the plurality of reeds from each of the at least two reed banks, wherein the modifying of each of the at least one waveform comprised in each of the at least one reed data is based on the identifying of the at least one reed data.

12. The reed musical instrument of claim 1, wherein the device further comprises at least one external sensor, wherein the at least one external sensor is disposed in an exterior of the body, wherein the at least one external sensor is communicatively coupled with the processing device, wherein the at least one external sensor is configured for detecting at least one characteristic of air associated with the exterior of the body, wherein the processing device is further configured for determining at least one relative characteristic based on the detecting of the at least one characteristic of the air associated with the exterior of the body and the detecting of the at least one characteristic of the airflow in the interior of the body, wherein the generating of the airflow information is based on the determining of the at least one relative characteristic.

13. The reed musical instrument of claim 1, wherein the at least one customization information comprises at least one value of at least one parameter for customizing the musical sound, wherein the device further comprises at least one display device, wherein the at least one display device is communicatively coupled with the processing device, wherein the at least one display device is configured for displaying the at least one value and the at least one parameter.

14. The reed musical instrument of claim 13, wherein the at least one parameter comprises at least one of a pitch, a reed combination, a drone tune, a volume, a pitch fine-tune, an air ventilation, a key preference, and an N-band audio equalization.

15. The reed musical instrument of claim 1, wherein the at least one customization information comprises a tuning information associated with a tuning of a musical note associated with the reed musical instrument with respect to at least one of a plurality of musical notes associated with the reed musical instrument.

16. The reed musical instrument of claim 1, wherein the device is removably implemented in the body.

17. The reed musical instrument of claim 2, wherein the at least one blocking element is removably implemented in the at least one reed for removably blocking the at least one reed.

18. A reed musical instrument for customizably producing musical sounds, the reed musical instrument comprising:
a body comprising an airflow device, at least one reed, and at least one key, wherein the airflow device is configured for establishing an airflow in an interior of the body, wherein the at least one key corresponds to the at least one reed;
a device configured to be implemented in the body, wherein the device comprises:
at least one switch configured for detecting at least one playing action corresponding to the at least one key;
at least one internal sensor disposed in the interior of the body, wherein the at least one internal sensor is configured for detecting at least one characteristic associated with the airflow;
a processing device communicatively coupled the at least one internal sensor and the at least one switch, wherein the processing device is configured for:
generating at least one key playing information based on the detecting of the at least one playing action;
generating an airflow information based on the detecting of the at least one characteristic associated with the airflow in the interior of the body; and
synthesizing at least one musical sound using at least one reed data associated with the at least one reed based on the at least one key playing information, the airflow information, and at least one customization information;
a storage device communicatively coupled with the processing device, wherein the storage device is configured for storing the at least one reed data; and
at least one output device communicatively coupled with the processing device, wherein the at least one output device is configured for producing the at least one musical sound based on the synthesizing of the at least one musical sound.

19. The reed musical instrument of claim 18, wherein the device further comprises at least one input device, wherein the at least one input device is communicatively coupled with the processing device, wherein the at least one input device is configured for receiving at least one input from at least one user, wherein the processing device is further configured for generating the at least one customization information based on the at least one input, wherein the synthesizing of the at least one musical sound using the at least one reed data is further based on the generating of the at least one customization information.

20. A reed musical instrument for customizably producing musical sounds, the reed musical instrument comprising:
a body comprising an airflow device, at least one reed, and at least one key, wherein the airflow device is configured for establishing an airflow in an interior of the body, wherein the at least one key corresponds to the at least one reed;
a device configured to be implemented in the body, wherein the device comprises:
at least one switch configured for detecting at least one playing action corresponding to the at least one key;
at least one internal sensor disposed in the interior of the body, wherein the at least one internal sensor is configured for detecting at least one characteristic associated with the airflow;
at least one external sensor disposed in an exterior of the body, wherein the at least one external sensor is configured for detecting at least one characteristic of air associated with the exterior of the body;
a processing device communicatively coupled the at least one internal sensor, the at least one external sensor, and the at least one switch, wherein the processing device is configured for:
generating at least one key playing information based on the detecting of the at least one playing action;
determining at least one relative characteristic based on the detecting of the at least one characteristic of the air associated with the exterior of the body and the detecting of the at least one characteristic of the airflow in the interior of the body;
generating an airflow information based on the determining; and
synthesizing at least one musical sound using at least one reed data associated with the at least one reed based on the at least one key playing information, the airflow information, and at least one customization information;
a storage device communicatively coupled with the processing device, wherein the storage device is configured for storing the at least one reed data; and
at least one output device communicatively coupled with the processing device, wherein the at least one output device is configured for producing the at least one musical sound based on the synthesizing of the at least one musical sound.
